(19) United States
(12) Patent Application Publication
(10) Pub. No.: US 2006/0105244 A1
(43) Pub. Date: May 18, 2006

(54) Lithium based electrochemical devices having a ceramic separator glued therein by an ion conductive adhesive

(76) Inventors: Joseph B. Kejha, Meadowbrook, PA (US); W. Novis Smith, Philadelphia, PA (US); Joel R. McCloskey, Philadelphia, PA (US)

Correspondence Address: Zachary T Wobensmith III, 7746 101 ST. COURT, VERO BEACH, FL, 32967-2871, US

(21) Appl. No.: 10/516,986

(22) PCT Filed: Jun. 8, 2002
(86) PCT No.: PCT/US02/18175

§ 371 Date: Dec. 6, 2004

(51) Int. Cl. H01M 4/74; H01M 2/16; H01G 9/008

(52) U.S. Cl. 429/242; 429/246; 429/251; 361/502

(57) ABSTRACT

Lithium based electrochemical devices which contain at least two porous electrodes, which include expanded metal microgrids coated with active materials, with a porous ceramic separator therebetween in adherent contact with one electrode, and an ionically conductive organic adhesive on said separator in adherent contact with said second electrode. A non-aqueous electrolyte is soaked into the electrodes and the separator with the device contained in an enclosure with two external terminals.

### BACKGROUND OF THE INVENTION

1. Field of the Invention

This invention relates to lithium based electrochemical devices which have a porous first electrode with a binder, a porous ceramic separator with a binder in bonding contact with the first electrode, a thin layer of ionically conductive organic adhesive on the separator, a porous second electrode with a binder, in contact with the polymeric adhesive layer, and a non-aqueous electrolyte, all contained within a moisture proof outer enclosure with external terminals.

2. Description of the Prior Art

Prior art lithium based electrochemical devices, and for example lithium-ion polymer batteries use plasticized polymeric solid separators sandwiched between plasticized electrodes, and laminated to the electrodes by heat welding, to make the cell assembly, as disclosed in U.S. Pat. No. 5,587,253 of Gozdz et. al. To make the cell porous for activation, the plasticizer must be extracted by a flammable solvent. The cell, after plasticizer extraction, is activated (soaked) by a non-aqueous flammable electrolyte, and sealed into a housing or pouch. Due to the softness of the separator material in the welding step, the separator must be relatively thick to prevent shorts, which decreases the energy density of the cell. If a thinner separator is used, the production yield is poor due to shorts. While the Gozdz's cell structure and method of assembly is adequate for certain applications, the cell's production is very labor intensive, with many steps and therefore costly. Since the extraction solvent is flammable, it is very hazardous to handle, and if the electrolyte is flammable it can also cause problems.

Yamashita et al. in U.S. Pat. No. 6,207,720 B1 discloses another cell structure and method of assembly, which employs a sole porous, thin ceramic separator disposed between porous electrodes. Both electrodes and the separator contain a binder which hold their particle materials together. The cell is held together by a housing, or the separator is coated onto a cathode or anode active layer, and is solidified by solvent evaporation, and the cell is then fused together by pressing and heating to melt the binder or by using a solvent capable of dissolving the binder to cause fusion. The solvent is removed and the cell is then activated by an electrolyte and sealed.

Although Yamashita et al. in U.S. Pat. No. 6,207,720 discloses an improved cell assembly over the prior art patents, the resulting cell structure has a major disadvantage, in that it produces a brittle ceramic separator, or an entire cell that is brittle, which may cause low yield in automated production process, or a size limitation due to cracking or crumbling and separation of the cell. The cell also has solid metal foil current collectors, which prevent fast evaporation of the solvent, and thus prevent fast solidification in production, as well as preventing fast activation by an electrolyte without using vacuum.

The U.S. Patent to Carlson et al. U.S. Pat. No. 6,306,545B1 discloses a separator only, not a bonded cell or device and the separator is limited to a pseudo-boehmite material layer.

The U.S. Patent to Kim et al. U.S. Pat. No. 6,268,087B1 discloses a laminated polymer cell, which is laminated after the individual components are activated by an electrolyte. It is not clear if the lamination means heat-welding of the cell together, or if the cell is held together only by vacuum packaging. The structure and methods are similar to Gozdz's cell above, and therefore it is also done with many steps and is costly.

The lithium based electrochemical devices of the invention do not suffer from the described problems and provide many positive advantages.

### SUMMARY OF THE INVENTION

It has now been found that lithium based electrochemical devices, and for example lithium-ion cells, capacitors and the like can be made with a single cell structure, which includes a porous first electrode with a binder, which may be an anode coated on a porous expanded metal microgrid current collector, a thin porous ceramic separator with a binder, coated on the first electrode active surface and solidified by solvent evaporation, a thin layer of ionically conductive organic adhesive layer coated preferably on the separator, a porous second electrode with a binder, which may be a cathode coated on a porous expanded metal microgrid current collector, and a non-aqueous electrolyte The active surface of the second electrode faces the adhesive layer on the separator and is pressed-on during assembly. The ionically conductive polymeric adhesive layer may be solidified by solvent evaporation, cooling, heating, electron beam radiation, or other well known methods.

The principal object of the invention is to provide electrochemical devices which preferably include a porous first electrode with a binder, a porous ceramic separator with an ionically conductive adhesive layer, a porous second electrode with a binder, and an electrolyte, housed in a moisture proof enclosure.

A further object of the invention is to provide electrochemical devices of the character aforesaid which can be single cell, bi-cell, single layer or double layer capacitor, supercapacitor or other electrochemical devices. A further object of the invention is to provide electrochemical devices of the character aforesaid which have improved electrochemical stability and mechanical flexibility due to an organic adhesive layer.

A further object of the invention is to provide electrochemical devices of the character aforesaid which have improved cycling characteristics and short proof structure due to the immobilized ceramic particles of the separator.

A further object of the invention is to provide electrochemical devices of the character aforesaid which are particularly suitable for mass production and which are non-flammable.

Other objects and advantageous features of the invention will be apparent from the description and claims.

### DESCRIPTION OF THE DRAWINGS

The nature and characteristic features of the invention will be more readily understood from the following description taken in combination with the accompanying drawings in which:

FIG. 1 is a side elevational and sectional view of an electrochemical device incorporating the invention, and

FIG. 2 is a top elevational plan view of the device of FIG. 1.

It should, of course, be understood that the description and drawings herein are merely illustrative and that various modifications, combinations and changes can be made in the structures disclosed without departing from the spirit of the invention.

Like numerals refer to like parts throughout the several views.

### DESCRIPTION OF THE PREFERRED EMBODIMENTS

When referring to the preferred embodiments, certain terminology will be utilized for the sake of clarity. Use of such terminology is intended to encompass not only the described embodiment, but also technical equivalents which operate and function in substantially the same way to bring about the same result.

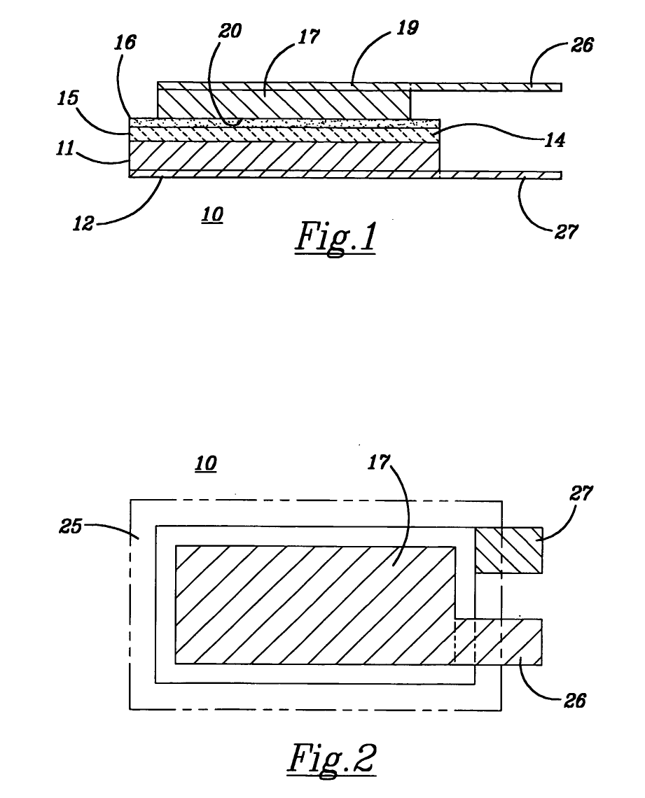

Referring now more particularly to the drawings and FIGS. 1 and 2 thereof, an electrochemical device 10 which in this instance is a lithium ion cell, is therein illustrated.

The cell 10 includes a porous first electrode 11, which may be an anode active material of well known type, which is coated onto a porous expanded metallic microgrid current collector 12, which anode also contains a binder. A thin porous ceramic separator 14 is provided which contains a binder (to be described), and electrically insulating particles coated on the active surface 15 of the first electrode 11, which separator is preferably solidified and immobilized by solvent evaporation. This solidification also makes the separator bond to the first electrode 11. A thin layer of ionically conductive organic adhesive 16 is then preferably coated on the separator 14 opposite to the first electrode 11. A second porous electrode 17 is provided with a binder, which may be a cathode active material of well known type, coated onto a porous expanded metallic microgrid current collector 19, which has the cathode active surface 20 facing the adhesive layer 16 and separator 14. The cathode active surface 20 is pressed onto the ionically conductive adhesive layer 16 during assembly of the cell (to be described). The second electrode 17 may be smaller than the separator 14 to avoid shorting at the edges.

The adhesive layer 16 may be solidified by solvent evaporation, cooling, heat, electron beam radiation or other well known methods as desired and dependent on the adhesive used.

Since the electrodes 11 and 17, the separator 14 and the current collectors 12 and 19 are porous, the solvent which may be contained in the adhesive layer 16 is easily evaporated resulting in improved adhesion and permanent cell bonding.

After assembly as described above, a high boiling electrolyte (not shown) is preferably added to the cell 10, which provides fast activation of the cell due to the porosity of the electrodes 11 and 17, and the separator 14. Because the solid adhesive layer 16 is in the middle of the cell, it does not block the activation.

Any conventional well known electrolyte which is compatible with the cell 10 components may also be used, such as 1 mole Li PF₆ in ethylene carbonate and dimethyl carbonate having a 1 to 1 ratio.

The cell 10 after activation is placed into a moisture proof enclosure 25, with exiting, sealed terminals 26 and 27.

Both the electrode coatings may be well known slurries as used in the coating of electrodes of liquid electrolyte, lithium-ion rolled cells, but the slurries in this invention are coated directly onto the expanded metal microgrids 12, and 19 by a doctor blade, slot coating or reverse roll coating. A support release film (not shown) is provided under the grids 12 and 19 until the coatings are solidified, and then calendered. The film (not shown) is removed before calendering.

The binder of the electrodes 11 and 17 and separator 14 may be of the same polymer, but preferably the polymers should be different for the electrodes 11 and 17, and the separator 14.

For example, the separator 14 binder may be polyvinylidene (PVDF) homopolymer, and the binder of the electrodes 11 and 17 may be polyvinyl alcohol (PVOH), or vice versa.

Since the different binders require different solvents, they will not dissolve the opposing layer when coated-on wet.

The following examples are preferred for use with lithium-ion polymer cells:

### A. Example 1 of the Ceramic Coating Slurry

1. 66 g N-Methylpyrrolidinone (NMP), Aldrich
2. 4.5 g PVDF Homopolymer, (Aldrich)
3. 90 g alpha alumina Al₂O₃ (1-1.5ᵤ, low Na.)

The NMP component is useful in a range of 40 to 60% by percentage weight, the PVDF component is useful in a range of 2 to 10% by percentage weight, and the alpha alumina component is useful in a range of 25 to 75% by percentage weight.

### B. Example 2 of the Ceramic Coating Slurry

1. 66 g deionized H₂₀
2. 4.5 g PVOH, 90K M.W.
3. (3)90 g LiF (1-1.5ᵤ).

It was also found that LiF improves ionic conductivity.

Other fluorides such as magnesium fluoride (MgF₂) are also suitable as are alumina and fluoride mixtures.

The H₂O component is useful in a range of 40 to 60%, by percentage weight, the PVOH component is useful in a range of 2 to 10% by percentage weight, and the fluoride component is useful in a range of 25 to 75% by percentage weight. Other electrically insulating particles are also useful, including organic particles, in similar slurries.

### C. Example #1 of the Ion-Conductive Adhesive

| | | |
|---|---|---|
| 1. | Solvent Dimethoxyethane (DME) (Aldrich) | 88 g |
| 2. | Polyvinylidene fluoride/hexafluoropropylene copolymer | 12 g |
| | PVDF/HFP 2801 (Atofina) | |
| 3. | Electrolyte 1.5M LiPF₆ in EC/PC 30% | 28 g |
| | (or 2M LiBF₄ in EC/PC 30%) | |
| 4. | Heat to 50° C. and mix in a closed vessel, then cool to room | |
| | temp. | |

where M = mole

The DME component is useful in a range of 40 to 95% by percentage weight, the PVDF/HFP component is useful in a range of 5 to 20% by percentage weight, and the electrolyte is useful in a range of 10 to 45% by percentage weight.

### D. Example #2 of the Ion-Conductive Adhesive

| | | |
|---|---|---|
| 1. | PVDF homopolymer (Aldrich) | 30 g |
| 2. | Electrolyte 2M LiBF₄ in EC/PC 30% | 70 g |
| 3. | Heat to 180° C. and mix under inert atmosphere (=hot melt) | |
| 4. | Coat hot and let cool to room temp. after cell assembly. | |

The PVDF component is useful in a range of 5 to 50% by percentage weight, and the electrolyte component is useful in a range of 50 to 95% by percentage weight.
Other well known lithium salts, such as Lithium Methide, Lithium Hexafluoroarsenate, Lithium Imide Lithium Triflate, Lithium Perchlorate and Lithium Beti are also suitable.

### E. Examples of Highly Conductive High Boiling (Low Flammability) Electrolytes

| | | |
|---|---|---|
| 1. | 1M LiPF₆ in EC/PC | 70/30% (7:3) ratio |
| 2. | 1M LiBF₄ in EC/PC | 70/30% (7:3) ratio |
| 3. | 2M LiBF₄ in EC/GBL | 80/20% (4:1) ratio |
| 4. | 2M LiBF₄ in EC (Eutectic), | |
| | or their mixtures. | |

Other well known lithium salts are also suitable for the above electrolytes.

The lithium salt components are useful in a range of 0.5M to 3M, the ethylene carbonate (EC) component is useful in a range of 40 to 90% by percentage weight, the propylene carbonate (PC) component is useful in a range of 10 to 70% by percentage weight, and the Gammabutyrolactone (GBL) component is useful in a range of 5 to 70% by percentage weight.

It has also been found that the viscous organic ion-conducting adhesives and high boiling (low-flammability) electrolyte liquids require more lithium salt than conventional flammable electrolyte liquids in order to overcome their higher viscosity (=resistance).

The main advantage of the cell of the invention over the prior art is in providing a safer high energy density and power density device with a thin, flexible structure, due to the organic adhesive layer, and a short proof structure, due to the adjacent immobilized porous ceramic particle layer and the high boiling, low flammability electrolyte. Manufacture of the cell of the invention is also easier due to lack of plasticizer, extraction step, and welding. The separator layer may be 1 mil or thinner, and the adhesive layer may be 1 mil or thinner.

It should be noted that the mixing and coating of the adhesive, and the cell assembly should be done under inert atmospheric conditions, and that the electrodes and the separator should be dried under vacuum for eight hours before gluing.

While the electrochemical device described herein is a lithium-ion single cell, the construction is equally applicable to bi-cell structures, as well as single or double layer capacitors, supercapacitors, and other electrochemical devices.

It will thus be seen that safe electrochemical devices of high energy density and power density have been provided with which the objects of the invention have been achieved.

We claim:

1. A lithium based electrochemical device comprising
at least two porous electrodes,
said electrodes include expanded metal microgrids having active materials coated thereon,
at least one porous ceramic separator between said electrodes,
said separator having one side in bonding contact with said first electrode active material,
an organic ion-conductive adhesive layer on the other side of said separator in adherent contact with said separator and said other electrode,
a non-aqueous electrolyte in contact with said electrodes, and said separator, and
an enclosure surrounding and containing said device.

2. An electrochemical device as defined in claim 1, in which said electrodes are an anode and a cathode.

3. An electrochemical device as defined in claim 1, in which said separator contains particles of an electrically insulating material and a binder.

4. An electrochemical device as defined in claim 3, in which said particles are alpha alumina particles.

5. An electrochemical device as defined in claim 3, in which said particles are inorganic lithium fluoride particles.

6. An electrochemical device as defined in claim 3, in which said particles are inorganic fluoride particles.

7. An electrochemical device as defined in claim 3, in which said particles are a mixture of inorganic fluoride and alumina particles.

8. An electrochemical device as defined in claim 1, in which said adhesive is PVDF/HFP copolymer based and contains at least one aprotic liquid and at least one salt.

9. An electrochemical device as defined in claim 1, in which said adhesive is PVDF homopolymer based and contains at least one aprotic liquid and at least one salt.

10. An electrochemical device as defined in claim 1, in which said electrolyte is high boiling and essentially non-flammable.

11. An electrochemical device as defined in claim 1, in which said electrolytes contain a binder.

12. An electrochemical device as defined in claim 3 and 11, in which said separator binder is of a different polymer than said electrodes' binders, and uses a different solvent.

13. An electrochemical device as defined in claim 1, in which said device is a bi-cell.

14. An electrochemical device as defined in claim 1, in which said device is a capacitor.

15. An electrochemical device as defined in claim 1, in which said device is a supercapacitor.

16. An electrochemical device as defined in claim 1, in which said device is a double layer capacitor.

17. An electrochemical device as defined in claim 1, in which said at least one electrode is smaller than said separator.

18. An electrochemical device as defined in claim 1, in which said separator comprises a mixture of N-methylpyrrolidinone in the range of 40 to 60% by percentage weight, polyvinylidene fluoride in the range of 2 to 10% by percentage weight, and alpha alumina in the range of 25% to 75% by percentage weight.

19. An electrochemical device as defined in claim 1, in which said separator comprises a mixture of H₂O in the range of 40% to 60% by percentage weight, polyvinyl alcohol in the range of 40% to 90% by percentage weight, and lithium fluoride in the range of 25% to 75% by percentage weight.

20. An electrochemical device as defined in claim 1, in which said separator is coated with an adhesive which is a mixture of dimethoxyethane in the range of 40% to 95% by percentage weight, polyvinylidene fluoride/hexafluoropropylene in the range of 5% to 20% by percentage weight, and a lithium based electrolyte in the range of 10% to 45% by percentage weight.

21. An electrochemical device as defined in claim 1, in which said separator is coated with an adhesive which is a mixture of polyvinylidene fluoride in the range of 5% to 50% by percentage weight, and/or a lithium based electrolyte in the range of 50% to 95% by percentage weight.
